(19) United States
(12) Patent Application Publication
(10) Pub. No.: US 2013/0329560 A1
(43) Pub. Date: Dec. 12, 2013

(54) RADIO COMMUNICATION SYSTEM, GATEWAY APPARATUS, AND DATA DISTRIBUTION METHOD

(71) Applicant: HITACHI, LTD., Tokyo (JP)

(72) Inventors: Yusuke SHOMURA, Tokyo (JP); Nodoka MIMURA, Kunitachi (JP); Masashi YANO, Kawasaki (JP)

(73) Assignee: Hitachi, Ltd., Tokyo (JP)

(21) Appl. No.: 13/869,495

(22) Filed: Apr. 24, 2013

(30) Foreign Application Priority Data
Jun. 12, 2012 (JP) 2012-132700

(51) Int. Cl. H04W 28/02

(52) U.S. Cl. CPC H04W 28/0247
USPC 370/235

(57) ABSTRACT

Radio communication system includes mobile terminal (UE), plurality of base stations connected by radio to the UE, gateway apparatus (GW) connected to the plurality of base stations, and data distribution server (SV) which is connected to the GW over the Internet and which distributes data to the UE. UE transmits a first data request (DR) and a second DR to the data distribution server through the base station and the GW. When the GW receives the first DR from the base station, GW transmits the received first DR to the data distribution server independent of a radio transmission load state from the base station to the UE. When the GW receives second DR from the base station, GW transmits the received second data request to the data distribution server with delay in accordance with radio transmission load state from the base station.

### CROSS-REFERENCE TO RELATED PATENT APPLICATIONS

Japan Priority Application 2012-132700, filed Jun. 12, 2012 including the specification, drawings, claims and abstract, is incorporated herein by reference in its entirety.

### BACKGROUND OF THE INVENTION

1. Field of the Invention

The present invention relates to radio communication systems which control traffic between a mobile terminal and a server, gateway apparatuses, and data distribution methods.

2. Description of the Related Art

In past mobile communications, e-mail services, Internet site viewing services and so on have been provided over a network protected by a mobile operator. However, with the wide spread of high-speed broadband mobiles of HSPA (High Speed Packet Access) and EV-DO (Evolution Data Only) that are 3G high-speed data communication services and WiMAX (Worldwide Interoperability for Microwave Access) and LTE (Long Term Evolution) which are called 3.9G, high-performance mobile terminals called smart phones have been almost commonly used and direct connection of a PC to the Internet through the high-speed broadband has been almost generally carried out. This may be achieved by connection in a TCP layer of TCP/IP (Transmission Control Protocol/Internet Protocol) established between a mobile terminal and a data distribution server over the Internet and transfer in an IP layer or under between relay nodes in a mobile communication network.

In a smart phone or a PC, traffics driven by an application which runs on the background occur frequently such as a traffic involved by an update of an OS (Operating System) and/or an application program (hereinafter, called an application), a traffic involved in data synchronization using a cloud and a traffic relating to application prefetch, in addition to a traffics driven by a user for e-mailing and Website viewing as in the past. For one reason that the communication of such a high-speed broadband mobile are charged on a flat rate basis, the traffic volume that flows to a mobile communication network has rapidly been increased, which disadvantageously deteriorates its communication quality.

On the other hand, according to “Wagakuni no Internet niokeru traffic souryou no haaku (Grasping Total Traffic Volume Over Internet in Japan)” (The Ministry of Public Management, Home Affairs, Posts and Telecommunications, http://www.soumu.go.jp/main_content/000055966.pdf), the broadband traffic volume has a large hourly fluctuation, and the time period of occurrence is largely biased as seen from the ratio between the bottom value and the peak value as high as approximately 2.2 times. In a mobile communication network, traffic locations are spatially biased due to movement of users. In order to maintain necessary communication quality, a network design based on a traffic peak may be demanded. However, because of limited channel capacity of radio sections and/or a constraint of capital investment, acquiring a sufficient channel capacity is difficult. When a traffic volume exceeds a network capacity, communication congestion or retransmission may occur, which further deteriorates the communication quality and therefore may significantly reduce user satisfaction. JP-A-2009-5310 discloses a method for preventing traffic burst which occurs when a broadcasting service is provided.

### SUMMARY OF THE INVENTION

Accordingly, it is an object of the invention to provide a communication service which allows effective use of a limited radio resource in consideration of a traffic characteristic as described above.

Data communications between a mobile terminal and a data distribution server in some applications may include a data communication with a large tolerant delay, that is, a data communication which may not be quickly implemented. For example, a data communication relating to an OS or application update may not be implemented quickly. According to the invention, when there is a sufficient network resource, data to a request with a small tolerant delay is only transmitted from a data distribution server to a mobile terminal. If there is a sufficient network resource, data to a request with a small tolerant delay and data to a request with a large tolerant delay are transmitted from a data distribution server to a mobile terminal.

Under this policy, a radio communication system as will be described below is constructed, for example, for traffic control to solve the problem. That is, there is provided a radio communication system including a mobile terminal, a plurality of base stations wirelessly connected to the mobile terminal, a gateway apparatus connected to the plurality of base station, and a data distribution server which is connected to the gateway apparatus over the Internet and which distributes data to the mobile terminal, wherein the mobile terminal transmits a first data request and a second data request to the data distribution server through the base station and the gateway apparatus, when the gateway apparatus receives the first data request from the base station, the gateway apparatus transmits the received first data request to the data distribution server independent of a radio transmission load state from the base station to the mobile terminal, when the gateway apparatus receives the second data request from the base station, the gateway apparatus transmits the received second data request to the data distribution server with a delay in accordance with a radio transmission load state from the base station to the mobile terminal, and when the data distribution server receives the first data request or the second data request from the gateway apparatus, the data distribution server transmits data requested by the first data request or second data request as response data to the mobile terminal through the gateway apparatus and the base station.

According to the invention, data distribution according to a tolerant delay may be allowed over a mobile communication network, resulting in effective use of a network resource. In other words, at a heavy network traffic hour, a data communication with a small tolerant delay may be implemented to prevent network congestion. When a network is not busy, a data communication with a small tolerant delay and a data communication with a large tolerant delay may be implemented. This allows flexible use of network resources without wasting.

### BRIEF DESCRIPTION OF THE DRAWINGS

FIG. 1 is a schematic configuration diagram of a radio communication system according to a first embodiment of the invention;

FIG. 2A is a hardware configuration diagram of a GW apparatus according to the first embodiment of the invention;

FIG. 2B is a hardware configuration diagram of a UE (mobile terminal) according to the first embodiment of the invention;

FIG. 2C is a hardware configuration diagram of an eNB (base station) according to the first embodiment of the invention;

FIG. 3 is a sequence diagram illustrating a data communication operation according to the first embodiment of the invention;

FIG. 4A illustrates a data request queue included in a DT-GW according to the first embodiment of the invention;

FIG. 4B illustrates a distribution data queue included in a DT-GW according to the first embodiment of the invention;

FIG. 4C illustrates a transmission band table included in a DT-GW according to the first embodiment of the invention;

FIG. 5 is a sequence diagram illustrating a data handling operation in a UE according to the first embodiment of the invention;

FIG. 6 illustrates a request management table included in a UE according to the first embodiment of the invention.

FIG. 7 is a flowchart illustrating an operation of managing a data request by a UE according to the first embodiment of the invention;

FIG. 8 is a sequence diagram of an operation by a radio communication system for data distribution to a UE in an idle state according to the first embodiment of the invention;

FIG. 9 is a sequence diagram illustrating an operation by a radio communication system for handover by a UE according to the first embodiment of the invention;

FIG. 10 illustrates a handover management table included in a DT-GW according to the first embodiment of the invention;

FIG. 11 is a flowchart illustrating an operation of dequeuing from a data request queue by a DT-GW according to the first embodiment of the invention;

FIG. 12 is a flowchart illustrating an operation of dequeuing from a distribution data queue by a DT-GW according to the first embodiment of the invention;

FIG. 13A illustrates a data request queue according to a second embodiment of the invention;

FIG. 13B illustrates a traffic statistical table included in a DT-GW according to the second embodiment of the invention;

FIG. 14 illustrates a packet format according to a third embodiment of the invention; and

FIG. 15 is a schematic configuration diagram of a radio communication system according to a fifth embodiment of the invention.

### DESCRIPTION OF PREFERRED EMBODIMENTS

### First Embodiment

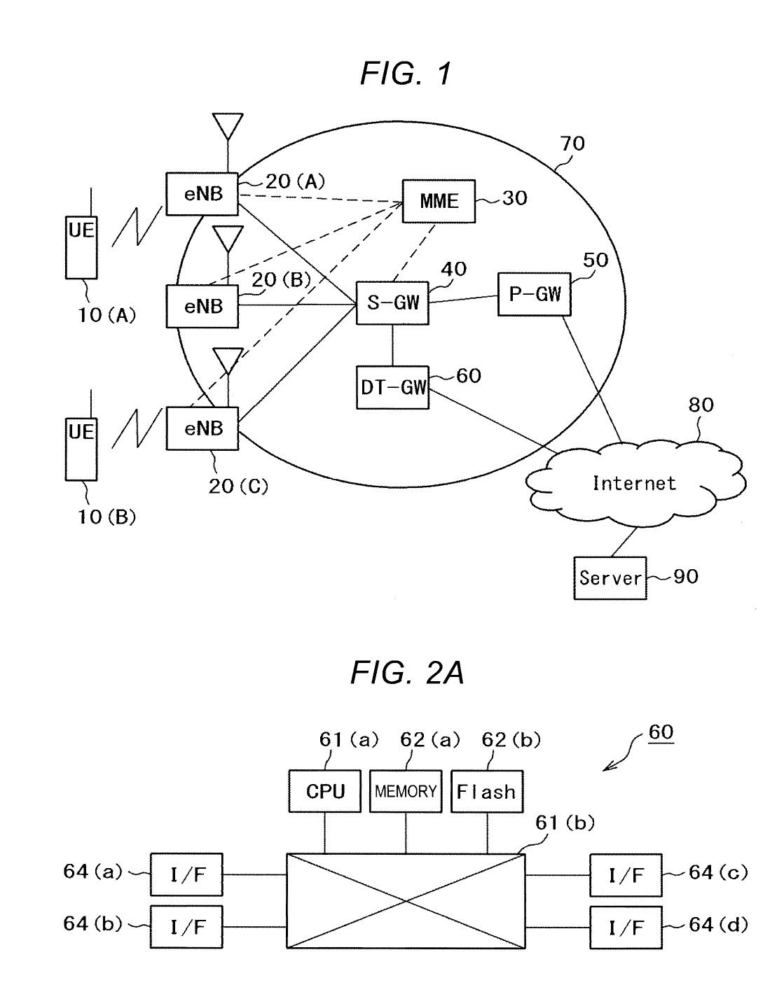

A first embodiment of the invention will be described with reference to FIGS. 1 to 12.

### Configuration of Radio Communication System

A configuration of a radio communication system according to the first embodiment will be described. FIG. 1 illustrates a schematic configuration of a radio communication system according to the first embodiment. In the illustrated example, a radio communication system of the invention is applied to an LTE called 3.9G. However, the invention is also applicable to a WiMAX or a 3G system. The radio communication system in FIG. 1 includes a plurality of UEs (User Equipment) 10, a plurality of eNBs (enhanced Node B) 20, an MME (Mobility Management Entity) 30, an S-GW (Serving GW) 40, a P-GW (Packet Data Network GW) 50, a DT-GW (Delay Tolerant GW) 60, and a data distribution server 90. Each of the UEs 10 is a mobile unit or a mobile terminal. The example in FIG. 1 includes a UE 10(A) and a UE 10(B). Each of the eNBs 20 is a base station. The example in FIG. 1 includes an eNB 20(A), an eNB 20(B) and an eNB 20(C). The MME 30 is a mobility management server and performs position management and/or authentication processing on the UEs 10.

The S-GW 40 is a first mobile gateway apparatus that functions as an anchor point within a radio network 70. The P-GW 50 is a second mobile gateway apparatus that functions as a boundary between a service network 80 and the radio network 70. The DT-GW 60 is a third mobile gateway apparatus that functions as a boundary between the service network 80 and the radio network 70. These gateway apparatuses are relay apparatuses which perform protocol conversion between different networks or relay data transmission and reception. The S-GW 40, P-GW 50 and DT-GW 60 may be configured as one gateway apparatus. The data distribution server 90 may store data such as data for updating an application and distribute the data to the UE or UEs 10.

These apparatuses are mutually connected over a network. More specifically, the UE 10(A) and UE 10(B) are connected to the eNB 20(A) and eNB 20(C), respectively, by radio. The eNB 20(A), eNB 20(B) and eNB 20(C) are connected to the S-GW 40 and MME 30. The S-GW 40 is connected to the MME 30, P-GW 50, and DT-GW 60. The P-GW 50 and DT-GW 60 are connected to the data distribution server 90 through the service network 80.

The radio network 70 is a network (radio access network) managed by an LTE service carrier. The service network 80 is an external network, such as the Internet, which provides a service to the UEs 10.

Illustrating an LTE system in FIG. 1, for example, a WiMAX system may have an ASN-GW (Access Service Network GateWay) having a function corresponding to the S-GW 40 and MME 30 and an HA (Home Agent) having a function corresponding to the P-GW 50. A 3G system may have an SGSN (Serving GPRS Support Node) having a function corresponding to the S-GW 40 and MME 30 and a GGSN (Gateway GPRS Support Node) having a function corresponding to the P-GW 50.

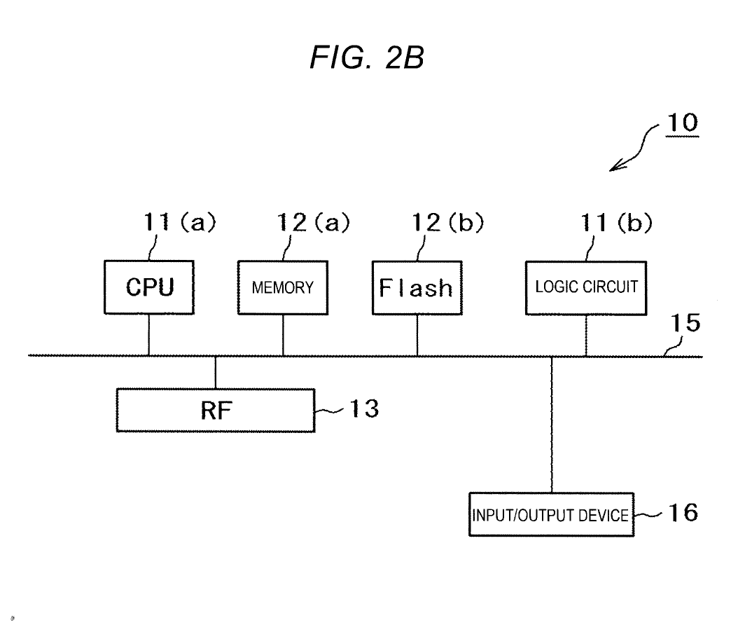

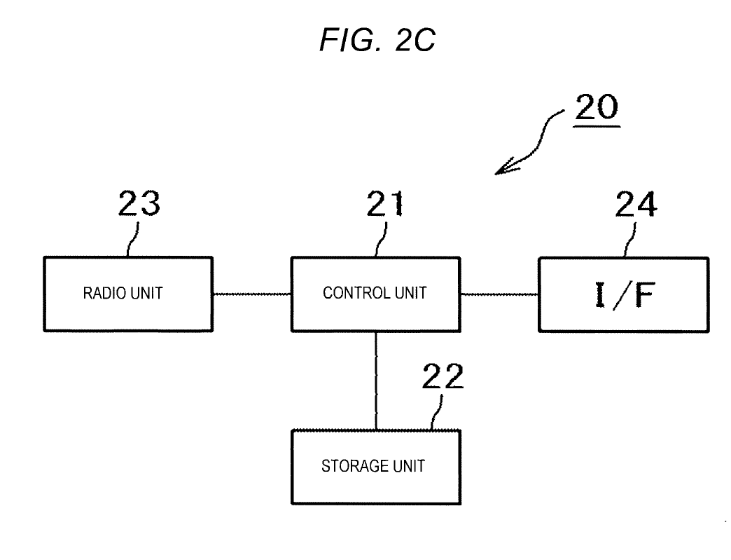

FIG. 2A is a hardware configuration diagram of the mobile gateway apparatus DT-GW 60 according to the first embodiment. The DT-GW 60 will be described exemplarily since other mobile gateway apparatuses S-GW 40 and P-GW 50 have a similar configuration to that of the DT-GW 60. The DT-GW 60 includes a CPU (Central Processing Unit) 61(a), a switch processing unit 61(b), a volatile memory 62(a), a non-volatile memory 62(b), and a plurality of communication interfaces (I/Fs) 64(a) to 64(d). These components are mutually connected through the switch processing unit 61(b).

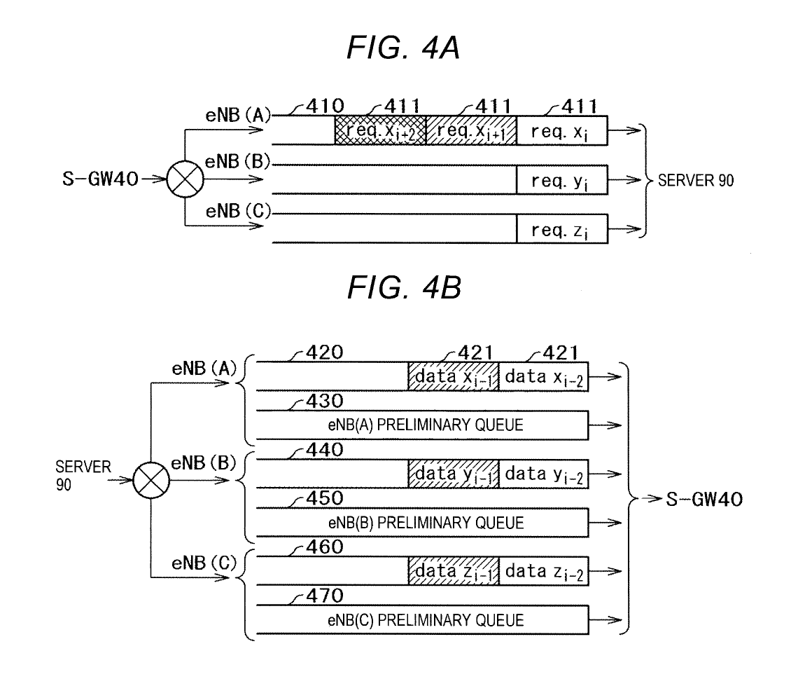

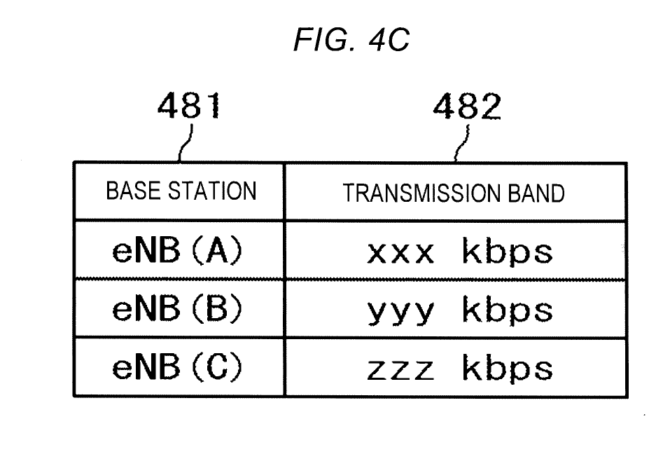

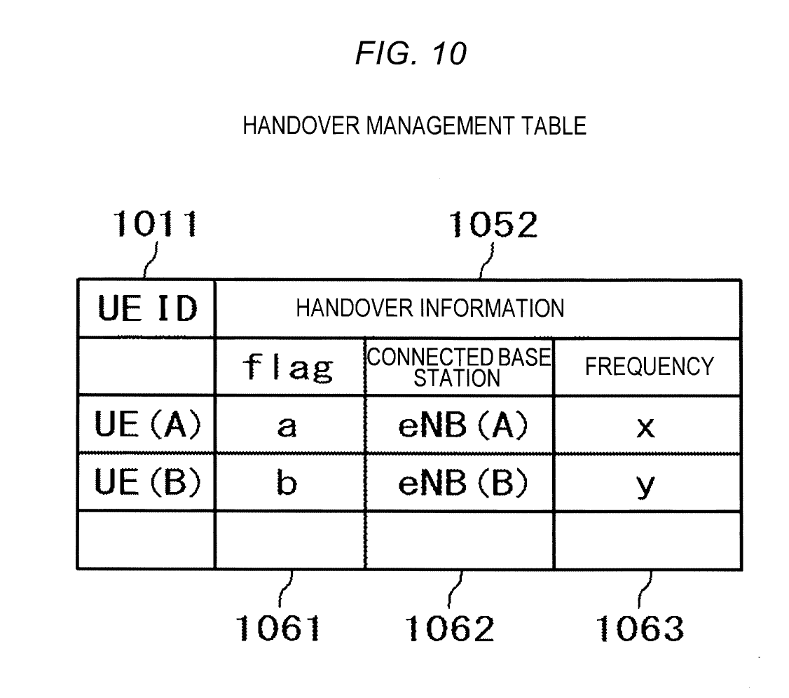

The CPU 61(a) may load and execute a program or the like from the non-volatile memory 62(b) to the volatile memory 62(a). In the DT-GW 60, the volatile memory 62(a) stores a program loaded from the non-volatile memory 62(b), a data request queue illustrated in FIG. 4A, a distribution data queue illustrated in FIG. 4B, a transmission band list illustrated in FIG. 4C, and a handover management table illustrated in FIG. 10, which will be described below. The CPU 61(a) may access a data request queue and/or a distribution data queue stored in the volatile memory 62(a) for executing a process. The non-volatile memory 62(b) may include a flash memory, for example, and store a program to be executed by the CPU 61(a) and/or configuration information.

The interfaces (I/Fs) 64(a) to 64(d) may receive a packet from the eNB 20 or another node (other GW and/or server) and transmit a packet processed by the CPU 61(a) to another node. The switch processing unit 61(b) connects to the CPU 61(a), volatile memory 62(a), nonvolatile memory 62(b), and interfaces (I/Fs) 64(a) to 64(d). The switch processing unit 61(b) may implement data transmission and reception between these elements.

The CPU 61(a) and switch processing unit 61(b) are included in a control unit 61 in the DT-GW 60. The volatile memory 62(a) and nonvolatile memory 62(b) are included in a storage unit 62 in the DT-GW 60. Operations of DT-GW 60, which will be described below, are controlled by the control unit 61.

Like the DT-GW 60, the S-GW 40 includes a control unit 41 including a CPU 41(a) and a switch processing unit 41(b) and a storage unit 42 including a volatile memory 42(a) and a nonvolatile memory 42(b). Operations of the S-GW 40, which will be described below, are controlled by the control unit 41. The P-GW 50 includes a control unit 51 including a CPU 51(a) and a switch processing unit 51(b) and a storage unit 52 including a volatile memory 52(a) and a nonvolatile memory 52(h). Operations of the P-GW 50 are controlled by the control unit 51.

Like the hardware configuration of the mobile gateway apparatus, each of the MME 30 and data distribution server 90 includes a CPU (Central Processing Unit), a switch processing unit, a volatile memory, a non-volatile memory, and a communication interface (I/F). The operations of the MME 30 and data distribution server 90 are controlled by a control unit including a CPU and a switch processing unit.

FIG. 2B is a hardware configuration diagram of a UE (mobile terminal) according to the first embodiment of the invention. The UE 10 includes a CPU 11(a), a logic circuit 11(b), a volatile memory 12(a), a non-volatile memory 12(b), a radio unit (RF) 13, and an input/output device 16. These components are mutually connected via a bus 15.

The logic circuit 11(b) is an electronic circuit which performs logic operation processing and may be an ASIC (Application Specific Integrated Circuit), an FPGA (Field Programmable Gate Array), a DSP (Digital Signal Processor), a DRP (Dynamically Reconfigurable Processor) or the like. A program to be executed in the UE 10 may be executed by a cooperative operation by the CPU 11(a), volatile memory 12(a), non-volatile memory 12(b), and logic circuit 11(b). It should be noted that their functions may be executed by the logic circuit or may be processed by the CPU, which may be changed as necessary.

The radio unit 13 is a radio interface for implementing radio communication to/from the eNB 20. The radio unit 13 may output by radio data supplied from the CPU 11(a), volatile memory 12(a), non-volatile memory 12(b) or logic circuit 11(b) to an external apparatus and/or supplies data input by radio from an external apparatus to the CPU 11(a), for example. The input/output device 16 is an apparatus such as a touch panel, a keyboard, a mouse, and a display which receives a user operation and displays data in response thereto. A user may operate the UE 10 through the input/output device 16. The input/output device 16 may not be included in the UE 10.

The CPU 11(a) and logic circuit 11(b) are included in a control unit 11 in the UE 10. The volatile memory 12(a) and nonvolatile memory 12(b) are included in a storage unit 12 in the UE 10. Operations of the UE 10, which will be described below, are controlled by the control unit 61.

FIG. 2C is a hardware configuration diagram of the eNB 20 according to the first embodiment of the invention. The eNB 20 includes a control unit 21 including a CPU, the storage unit 22 including a volatile memory and a non-volatile memory, a radio unit 23, and an interface (I/F) 24. The radio unit 23 is a radio interface for implementing radio communication to/from the UE 10. The interface (I/F) 24 is an interface for implementing communication such as data transmission and reception to/from the S-GW 40 and/or MME 30. The operations of the eNB 20, which will be described below, are controlled by the control unit 21.

### Operations of Mobile Terminal for Acquiring Data

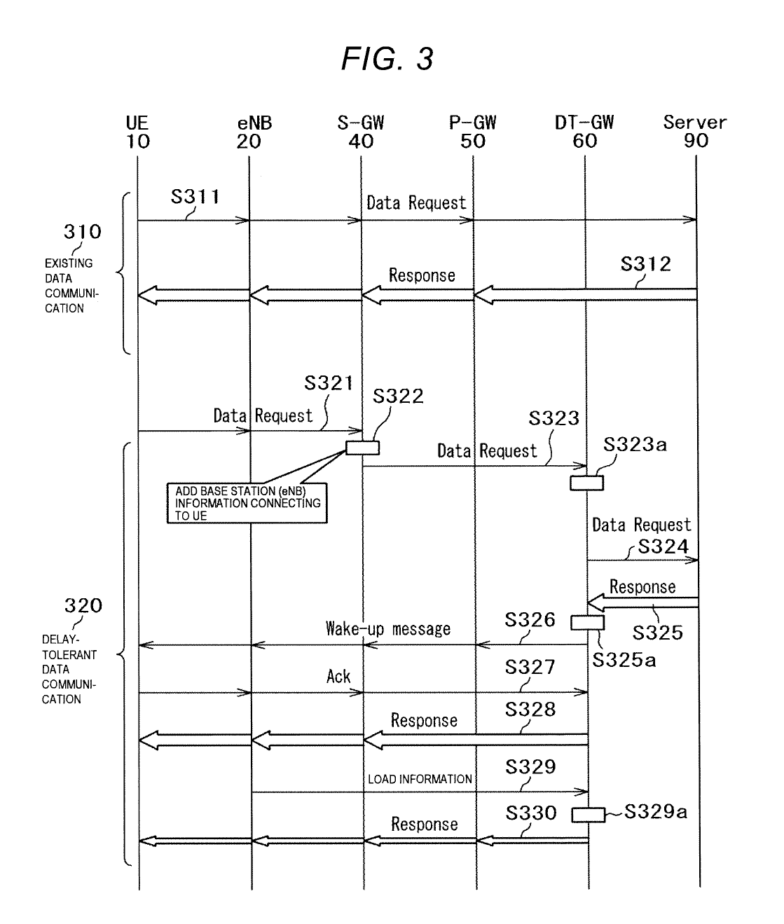

Next, operations of a mobile terminal for acquiring data from a data distribution server will be described. FIG. 3 is a sequence diagram illustrating operations of the UE 10 for acquiring data from the external data distribution server 90 in the first embodiment. The data distribution server 90 stores in its storage unit data supplied to the UE 10. In order to acquire data, one of two types of method 310 which uses existing data communication and a method 320 which uses delay tolerant data communication may be used. The delay-tolerant data communication intentionally delays a data communication as the situation demands. The existing data communication 310 is a data communication which requires immediate communication, that is, a data communication which does not tolerate delay. The expression that data communication which does not tolerate delay refers to a data communication which is not delayed intentionally, compared with the delay-tolerant data communication. The existing data communication 310 establishes a direct TCP session between the UE 10 and the data distribution server 90 for data transmission and reception.

The delay-tolerant data communication 320 is a communication through the DT-GW 60. The DT-GW 60 once stores data received from the UE 10 or data distribution server 90, like a proxy server, and distributes data when the eNB 20 has a small load. The delay-tolerant data communication 320 is a communication method supporting data communication with low urgency which may not be performed immediately, and data distribution is performed on the initiative of a mobile communication network. In other words, when a mobile communication network has a small load, especially when the eNB 20 has a small load, response data is distributed to the UE 10. When the eNB 20 has a large load, the distribution of response data is temporarily stopped to avoid congestion. The data distribution on the initiative of a mobile communication network may improve efficiency of use of the network.

Details of a sequence in each communication will be described below.

### Existing Data Communication

In the existing data communication 310, the UE 10 issues a data request destined to the server 90 (S311). The data request 5311 contains a destination address (address of the server 90), a source address (address of the UE 10), and an URI (Uniform Resource Identifier) which is data designation information that designates data to be distributed. The data request 5311 reaches the server 90 through the eNB 20, S-GW 40, and P-GW 50. A response 5312 to the data request 5311 is transmitted from the server 90 and reaches the UE 10 through the P-GW 50, S-GW 40, and eNB 20. Here, the eNB 20, S-GW 40, and P-GW 50 perform processing including capsulation and decapsulation on data (data request 5311 and response 5312) and relay the data.

For example, the eNB 20 adds, for the data (data request S311) received from the UE 10, the eNB information (base station information) which uniquely designates the eNB 20 as a header (capsulation) and transmits it to the S-GW 40. The S-GW 40 replaces the eNB information at the header of the data received from the eNB 20 by P-GW information which uniquely designates the destination P-GW 50 and transmits it to the P-GW 50. The P-GW 50 deletes the P-GW information at the header of the data received from the S-GW 40 (decapsulation) and transmits it to the server 90. The eNB 20, S-GW 40, and P-GW 50 perform reverse processing of the processing above on the data received from the server 90.

### Delay-Tolerant Data Communication

On the other hand, in the delay-tolerant data communication 320, the UE 10 issues a data request destined to the DT-GW 60 (S321). The data request 5321 contains an address of the destination DT-GW 60 and a source address (address of the UE 10), and data designation information URI which designates data to be distributed. The S-GW 40 having received the data request 5321 destined to the DT-GW 60 through the eNB 20 adds, for the data request 5321 received from the eNB 20, the eNB information (base station information) on the eNB connecting to the UE 10 (S322) and transfers it to the DT-GW 60 (S323). The DT-GW 60 inputs the data request 5323 received from the S-GW 40 to a data request queue illustrated in FIG. 4A in the reception order, for example, for management.

The data request queue is configured to output data which is input first. As illustrated in FIG. 4A, the data request queue is prepared for each base station. The data request S323 received from the S-GW 40 is allotted to each base station in step S323a on the basis of the base station information added by the S-GW 40 in step S322. In the example in FIG. 4A, a data request 411 (Xᵢ₊₂), a data request 411 (Xᵢ₊₁), and a data request 411 (Xᵢ) are input to the data request queue 410 prepared for each eNB (A). The data request 411 (Xᵢ) is data input first and is to be output first. Each of the data requests 411 is configured to contain a UE ID that is an ID (identifier) which uniquely designates the data request source UE 10. The UE ID is a source address (address of the UE 10) contained in the data request S321.

The data request transmission (S324) to the server 90 illustrated in FIG. 3 is performed when a data request is dequeued (output) from a data request queue. The dequeuing is performed if the queue length of a distribution data queue (FIG. 4B) used for data transmission to the UE 10 by the DT-GW 60 is lower than a predetermined threshold value.

As illustrated in FIG. 3, the server 90 having received the data request S324 returns a response (Response) to the data request 5324 to the DT-GW 60 (S325). If an error message is returned from the server 90 as a result of the data request to the server 90 (S324), the error message is returned as a response to the DT-GW 60. For example, if the requested data is not available in the server 90, the server 90 returns an error message.

If the DT-GW 60 receives the response 5325 from the server 90, data combining the response S325 and the data request 411 transmitted to the server 90 is enqueued (input) to a distribution data queue illustrated in FIG. 4B (S325a). The distribution data queue, like a data request queue, is also prepared for each base station, and the data is enqueued to a distribution data queue for the same base station as the one having transmitted the data request 411 to the server 90. For example, a response to the data request 411 dequeued from a data request queue for the eNB (A) is enqueued to a distribution data queue for the eNB (A).

In the example in FIG. 4B, distribution data queues 420 and 430 are prepared for the eNB (A), distribution data queues 440 and 450 for the eNB(B), and distribution data queues 460 and 470 for the eNB(C). The queues 420, 440 and 460 are normal queues to which response data received from the data distribution server 90 are input. The queues 430, 450 and 470 may be used as preliminary queues to which response data dequeued from a normal queue is input, for example. Detail usages of the preliminary queues will be described below. Data 421 (Xᵢ₋₁) and data 421 (Xᵢ₋₂) are input to the distribution data queue 420 prepared for the eNB (A). The data 421 (Xᵢ₋₂) is data input first and is to be output first to the eNB (A) through the S-GW 40.

The DT-GW 60 dequeues response data from the distribution data queue and transmits the response data to the UE 10 through the S-GW 40 and eNB 20 (S328). Before transmitting response data to the UE 10, the DT-GW 60 first transmits a start message to the UE 10 (S326). The start message contains a URI by which distribution data requested with the data request 5321 by the UE 10 is identifiable. The UE 10 having received the start message returns an Ack when it is ready to receive (S327). The DT-GW 60 having received the Ack transmits the response data (Response) to the UE 10 (S328). The S-GW 40 and eNB 20 relay the start message, the Ack and response data by performing processing including capsulation and decapsulation, for example. The eNB 20, S-GW 40, and DT-GW 60 relay the data request S321 and/or response S328 by performing processing including capsulation and decapsulation, for example.

A start message is transmitted from the DT-GW 60 to the UE 10 to enable the UE 10 to receive response data from the data distribution server 90 when the UE 10 has an idle state. The term idle state refers to a state where a communication path between the UE 10 and the eNB 20, S-GW 40, and DT-GW 60 does not exist and the destination of distribution data from the data distribution server 90 is not identifiable, for example.

When response data is transmitted from the DT-GW 60 to the eNB 20 through the S-GW 40, the transmission band is prevented from exceeding the transmission band on a transmission band list illustrated in FIG. 4C. The transmission band list illustrated in FIG. 4C is a table containing base station information 481 and transmission band information 482 and provides an available transmission band for each base station. For example, in the example in FIG. 4C, the transmission band for response data to the eNB(A) is limited to xxx kbps or below.

The eNB 20 may be configured to transmit a message containing load information on the eNB 20 to the DT-GW 60 periodically, when a load (or radio transmission load) on the eNB 20 exceeds a predetermined first threshold value (upper threshold value), or when the load on the eNB 20 is lower than a predetermined second threshold value (lower threshold value) (S329). The load on the eNB 20 is a traffic load on a radio link for radio transmission from the eNB 20 to the UE 10. The load information on the eNB 20 may be a queue length, which is stored within the eNB 20, of transmit data from the eNB 20 to the UE 10. Thus, when the load on the eNB 20 is large, the transmission band for response data to the eNB 20 may be reduced.

The DT-GW 60 having received this load information message (S329) changes the transmission band of the base station on the transmission band list in accordance with the load condition of the eNB 20 to adjust the transmission band to the base station (S329a). Hence, the DT-GW 60 may transmit response data from the data distribution server 90 to the eNB 20 through the S-GW 40 at an appropriate data transmission rate (S330).

FIG. 4A illustrates one of the simplest examples of a data request queue which has one data request queue for each base station. However, a plurality of data request queues may be provided for each base station for parallel data request queues. When a plurality of queues are provided for each base station, the queues may be distributed equally or in accordance with the ID of the UE 10 and/or the type of data request when the data request is to be enqueued. Dequeuing may be scheduled by a general queue management method such as dequeuing at equal intervals or dequeuing by weighting.

### Operations of Handling Data in UE

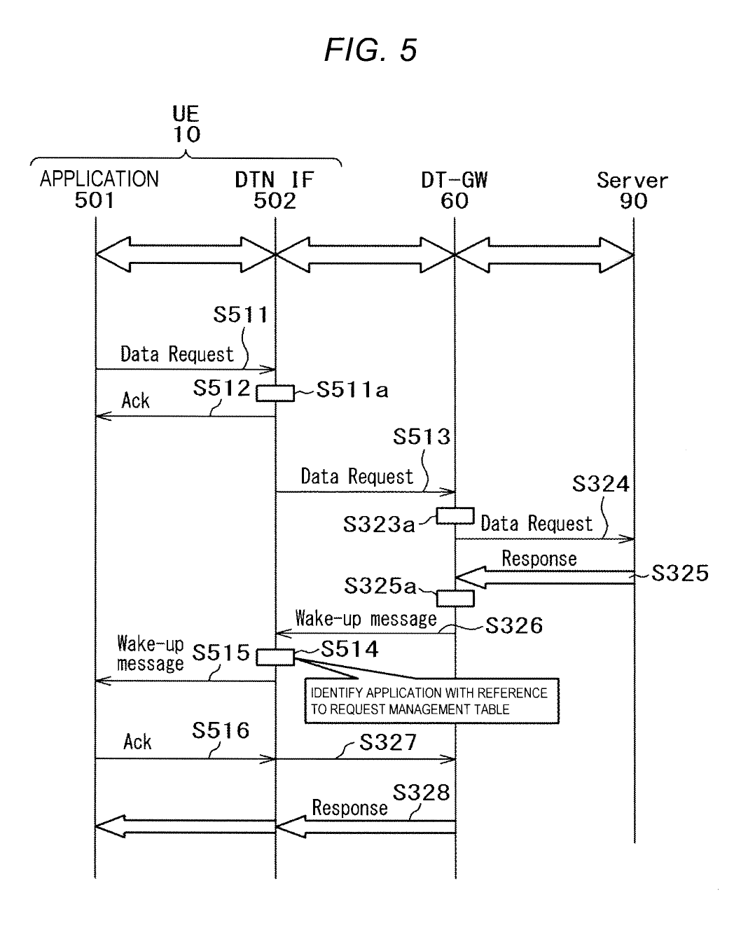

Next, according to the first embodiment of the invention, operations of handling data in a UE will be described with reference to FIG. 5 to FIG. 7.

FIG. 5 is a sequence diagram illustrating an internal processing operation of the UE 10 using the delay-tolerant data communication 320 and specifically illustrating communication layers including a TCP layer and higher layers. A developer of an application or a user of the UE 10 may set in advance in an application of the UE 10 which communication is the “delay tolerant communication 320” and which communication is the immediate-execution required communication 310″.

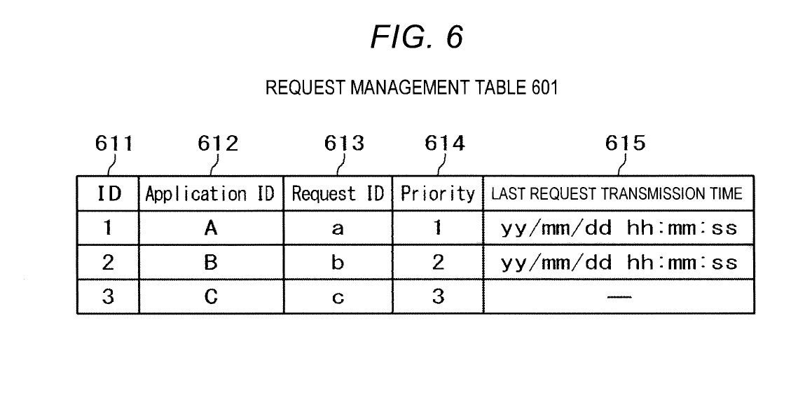

When a delay tolerant communication occurs in an application 501 of the UE 10, the application 501 transmits a data request to a DTN-IF program (hereinafter called a DTN-IF) 502 in the UE 10 (S511). The DTN-IF (Delay Tolerant Networking-Interface) is a program for performing a delay tolerant communication. The DTN-IF 502 having received the data request stores information regarding the received data request in a request management table 601 illustrated in FIG. 6 (S511a) and returns an Ack to the application 501 (S512). The application 501 having received the Ack has an idle state or executes other process until it receives a start message from the DTN-IF 502 (S515).

The “delay tolerant communication 320” and the “immediate-execution required communication 310” may be distinguished automatically on the basis of the state of the UE 10 or statistically. For example, they may be distinguished according to a rule based method, for example, including an empirical rule that a data request occurring when the screen of the UE 10 has an OFF state is for the “delay tolerant communication 320” or by a method including mechanical learning.

The request management table 601 illustrated in FIG. 6 is a table held by the UE 10 of the first embodiment in the storage unit 62 and contains ID 611, application ID 612, request ID 613, priority 614, and last request transmitted time 615. The ID 611 stores an identifier by which an entry (a line of the table) may be uniquely identifiable. The application ID 612 stores an identifier (such as a process ID) of the application 501 having issued a data request. The request ID 613 stores an identifier such as a URI by which distribution data requested by a data request may be uniquely identifiable. The priority 614 stores a priority level of delay tolerance. The last request transmitted time 615 stores the last time when a data request is transmitted to the DT-GW 60.

When the UE 10 receives a response from the data distribution server 90 corresponding to the data request of each entry in the request management table 601, the UE 10 deletes the data in the entry.

The request management table 601 may store a data request from an application, or a different storage unit 62 than the request management table 601 may store it in association with the request ID 613.

The symbol “-” in the last request transmitted time 615 for the data request with 3 in the ID 611 indicates that the data request received by the DTN-IF 502 from the application 501 has not been transmitted to the DT-GW 60.

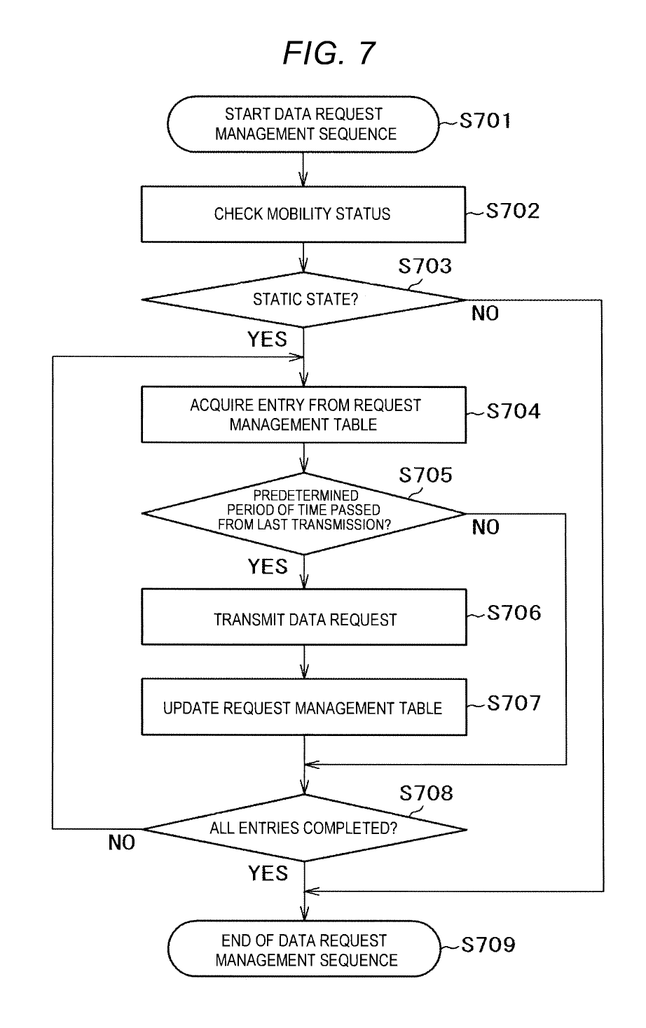

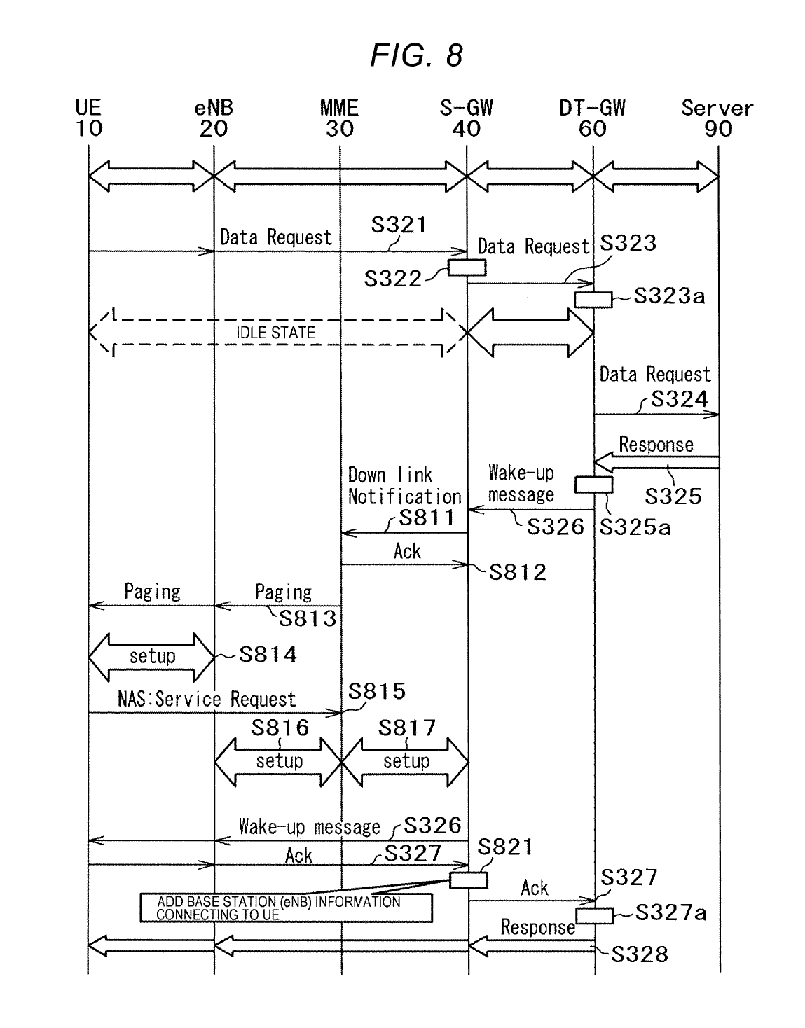

The DTN-IF 502 having returned the Ack (S512) transmits the data request to the DT-GW 60 by following the flowchart illustrated in FIG. 7 (S513). Because the processing of the DT-GW 60 and the processing (S323a to S325a) of the server 90 are similar to the processing (S323a to S325a) illustrated in FIG. 3, the same references are used as those in FIG. 3, and the descriptions will be omitted. When the DTN-IF 502 receives a start message from the DT-GW 60 (S326), the DTN-IF 502 identifies the application 501 having issued a data request with reference to the request management table 601 (S514) and transmits the start message to the application 501 (S515). When the DTN-IF 502 receives an Ack from the application 501 (S516), the DTN-IF 502 returns the Ack to the DT-GW 60 (S327). When the DT-GW 60 receives an Ack, the DT-GW 60 transmits response data to the DTN-IF 502 (S328).

FIG. 7 is a flowchart illustrating an operation for transmitting a data request from the UE 10 (DTN-IF 502) to the DT-GW 60. In the delay-tolerant data communication 320 according to this embodiment, the UE 10 is configured to be responsible for the arrival of response data for simplified system configuration. In other words, when response data does not arrive, the UE 10 may be required to transmit a data request again. For improved efficiency of use of a network, data distribution to the UE 10 that is moving is inhibited as much as possible.

As illustrated in FIG. 7, when the DTN-IF 502 receive a data request from the application 501 and periodically, the DTN-IF 502 starts a data request management sequence (S701). The DTN-IF 502 first checks the mobility state of the UE 10 (S702). The mobility state may be acquired from beacon information (information for acquiring positional information of the UE 10) from the eNB 20 received by the UE 10 or a GPS (Global Positioning System) installed in the UE 10. The DTN-IF 502 determines that the UE 10 has a static state if the DTN-IF 502 receives beacon information continuously from one base station. If it is determined that the UE 10 is moving (No in S703), the DTN-IF 502 exits the data request management sequence (S709).

If the UE 10 stays still for a predetermined period of time (Yes in S703), the DTN-IF 502 acquires one of entries (table line) from the request management table 601 (S704). If a predetermined period of time has not passed from the last request transmitted time 615 (No in S705), the processing on the entry ends, and the method moves to S708, which will be described below. If the predetermined period of time has passed from the last request transmitted time 615 of the entry (Yes in S705), the DTN-IF 502 transmits a data request to the DT-GW 60 through the eNB 20 (S706), the request transmitted time 615 on the request management table 601 is updated (S707). If the update processing on the request management table 601 completes (S707), the processing on the entry ends. If the processing from steps S704 to S707 completes on all entries (Yes in S708), the data request management sequence ends (S709). The predetermined period of time used in step S705 may be set for each priority level 614 in the request management table 601. For example, a data request with a low priority level may be retransmitted after a lapse of a longer period of time. Illustrating an example in which data requests that satisfy the condition in step S705 are sequentially transmitted in the flowchart in FIG. 7, all data requests that satisfy the condition in step S705 may be extracted first and then be transmitted to the DT-GW 60 by one operation.

Operations When UE Shifts to Idle State after Data Request

Next, operations when the UE 10 shifts to an idle state after a data request will be described with reference to FIG. 8. FIG. 8 is a sequence diagram illustrating operations of a radio communication system according to the first embodiment of the invention for distributing data to the UE 10 having shifted to an idle state after a data request.

In FIG. 8, because the processing from S321 of transmitting a data request from the UE 10 to S326 of transmitting a start message (Wake-up message) from the DT-GW 60 is similar to the processing (S321 to S326) in FIG. 3, the description will be omitted.

As illustrated in FIG. 8, if the S-GW 40 receives a start message (S326), processing of connecting the UE 10 having an idle state to a network is performed (S811 to S817). The S811 to S817 are publicly known processing. More specifically, the S-GW 40 notifies the arrival of a packet to the MME 30 to cause paging (S811) and buffers the packet (start message) received from the DT-GW 60, that is, stores it in the storage unit 42 in the S-GW 40. The MME 30 returns a response (Ack) to the message (S811) from the S-GW 40 to the S-GW 40 (S812) and transmits a paging request destined to the UE 10 to the eNB 20 belonging to the corresponding paging area (S813). The paging request is for inquiring the position of the UE 10. The eNB 20 transmits the paging request received from the S-GW 40 to the UE 10 by radio. If the UE 10 receives the paging request from the eNB 20, the UE 10 sets a radio link to the eNB 20 (S814). The eNB 20 having a radio link to the UE 10 establishes a communication path to the S-GW 40 through the MME 30 (S815 to S817). Here, S815 is performed in a NAS (Non Access Stratum) and executes a service request to the MME 30 through Non Access Stratum.

After the S-GW 40 establishes a communication path to the eNB 20, the S-GW 40 transmits the packet (start message) buffered in the storage unit 42 to the UE 10 through the eNB 20 (S326). If the UE 10 receives the start message, the UE 10 transmits an Ack message destined to the DT-GW 60 through the eNB 20 (S327). If the S-GW 40 receives the Ack message, the S-GW 40 adds base station information on the eNB 20 connecting to the UE 10 to the received Ack message (S821) and transmits it to the DT-GW 60. The DT-GW 60 having received the Ack message from the S-GW 40 transmits a response data to the UE 10 through the S-GW 40 and eNB 20 (S328).

If the UE 10 connects to a different base station (such as the eNB 20(B)) from the base station (such as the eNB 20(A)) having transmitted the data request S321 and transmits an Ack to the start message (S327) while moving in one paging area, the DT-GW 60 detects that the UE 10 has moved from the base station information added in the S-GW 40. If the response data in the distribution data queue (420 in FIG. 4B) for the eNB 20(A) is taken out (or dequeued), the DT-GW 60 enqueues the dequeued response data to a preliminary queue 430 (that is, a preliminary queue for a base station currently connecting to the UE 10) to a distribution data queue for the eNB 20(B). The enqueuing in a preliminary queue may prevent the transmission of response data (S328) from waiting and delaying.

When a plurality of queues including a preliminary queue are provided for distribution data queues each for a base station, a transmission rate among the plurality of queues is preset. The transmission band for a combination of a plurality of queues for one base station is lower than the transmission band for the base station on the transmission band list in FIG. 4C. In a configuration without a preliminary queue, the dequeued response data may be enqueued to a distribution data queue for the base station (eNB 20(B)) currently connecting to the UE 10.

Having described according to this embodiment that the MME 30 performs the paging processing on the all base stations belonging to a paging area, the paging may be performed limitedly to the base station (eNB 20(A)) through which the UE 10 has transmitted a data request. When the DT-GW 60 receives an Ack to the start message (S327) and if the UE 10 is not connected to the base station (eNB 20(A)) used for transmitting the data request, the response data is discarded from the distribution data queue for the eNB 20(A). In order to limit the paging by the MME 30 to one base station, the DT-GW 60 adds the base station information (eNB 20(A)) for the paging to the start message (S326). The S-GW 40 adds the base station information to the message (S811) and transmits the message to the MME 30.

Operations for Handover between Base Stations After Data Request By Mobile Terminal

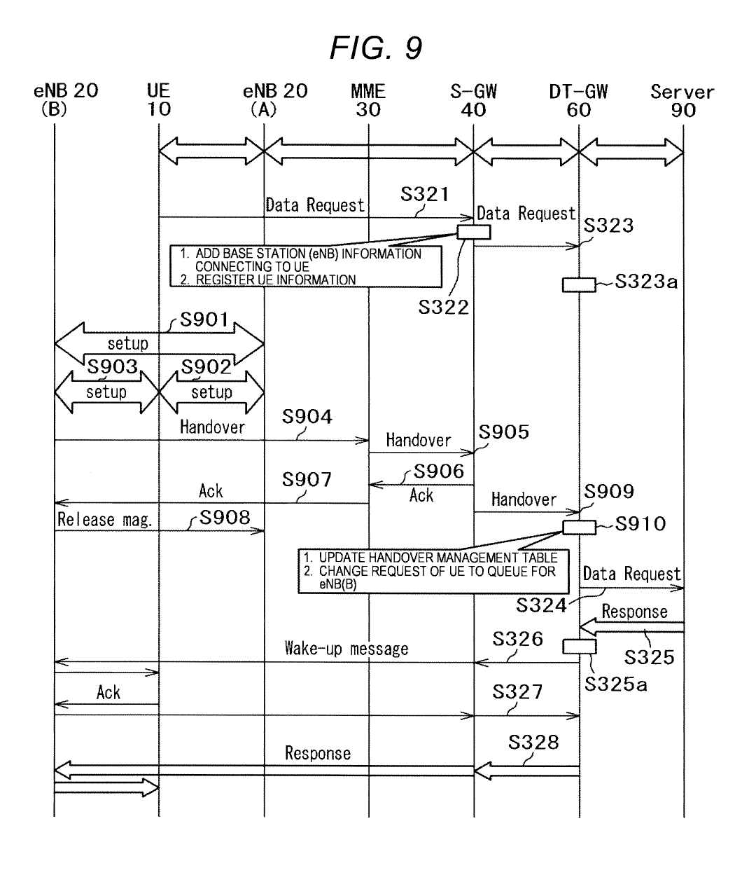

Next, operations for handover of a base station after a data request by a mobile terminal will be described with reference to FIG. 9. FIG. 9 is a sequence diagram illustrating an operation of a radio communication system upon handover between base stations after a data request by the UE 10 according to the first embodiment of the invention. In FIG. 9, because the processing in 5321 to S323a and 5324 to 5328 is similar to the processing (S321 to S323a and 5324 to 5328) in FIG. 3, the description will be omitted.

A handover starts with setup (setup S901) and completes with a release message (Release msg. S908). A message sequence in S901 to S908 is similar to the publicly known handover processing in LTE.

More specifically, if the eNB 20(A) determines that the UE 10 needs a handover, the eNB 20(A) transmits a handover (HO) request to the destination target eNB 20(B) and exchanges information for radio link setting with it (S901). If the eNB 20(A) receives a response confirmation to the handover request from the eNB 20(B), the eNB 20(A) transmits a handover instruction to the UE 10 (S902) and transmits PDCP sequence number information to the eNB 20(B). If the UE 10 connects to the destination eNB 20(B), the UE 10 transmits a handover confirmation message to the eNB 20(B) (S903). If the eNB 20(B) receives the handover confirmation message, the eNB 20(B) transmits a path change request message to the MME 30 (S904). The MME 30 transmits a U-(user) plane update request to the S-GW 40 and notifies the information on the eNB 20(B) (S905). The S-GW 40 returns a U plane update response to the MME 30 and starts transmitting a downlink packet to the UE 10 (S906). The MME 30 returns a path change request confirmation message to the eNB 20(B) (S907), and the eNB 20(B) notifies the success of the handover to the destination eNB 20(A) (S908).

According to this embodiment, a message “Handover” (S909) from the S-GW 40 to the DT-GW 60 is newly added. The message S909 contains an ID of the UE 10 and base station information on the source and the destination. The S-GW 40 may hold UE information (UE ID) in a data request in a list format, for example, in the storage unit 42 in the S-GW 40 (S323) and may transmit it to the DT-GW 60 only for handover to a UE 10 included in the list. In this case, the UE information in a data request may be acquired by updating it by periodically transmitting it from the DT-GW 60 or by predicting on the basis of the measured number of requests and number of responses from the UE 10.

The DT-GW 60 having received the “Handover” (S909) manages the handover information on a handover management table provided within the storage unit 62 in the DT-GW 60. FIG. 10 illustrates an example of the handover management table. The handover management table in FIG. 10 contains UE ID 1011 and handover information 1052. The handover information 1052 contains flag information 1061, connected base station information 1062, and frequency information 1063. The UE ID 1011 contains an identifier by which a UE 10 is uniquely identifiable. The flag information 1061 in the handover information is flag information indicative of the presence of occurrence of a handover and indicates “1” when a handover occurs after the data request (S323) is received. The connected base station information 1062 holds the latest information on the base station to which the LTE 10 is connected. The frequency information 1063 contains information indicating the frequency of the latest handover. “1” may be added to the frequency information upon occurrence of a handover, and “1” is subtracted therefrom at predetermined periods until it reaches “0”, for example.

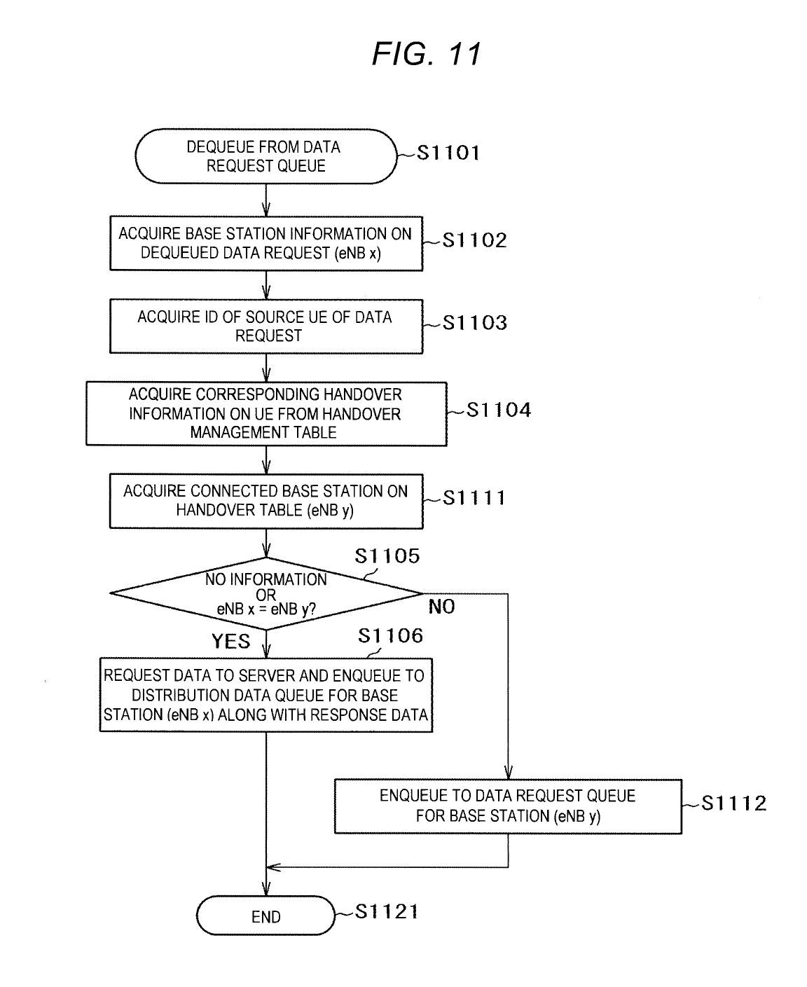

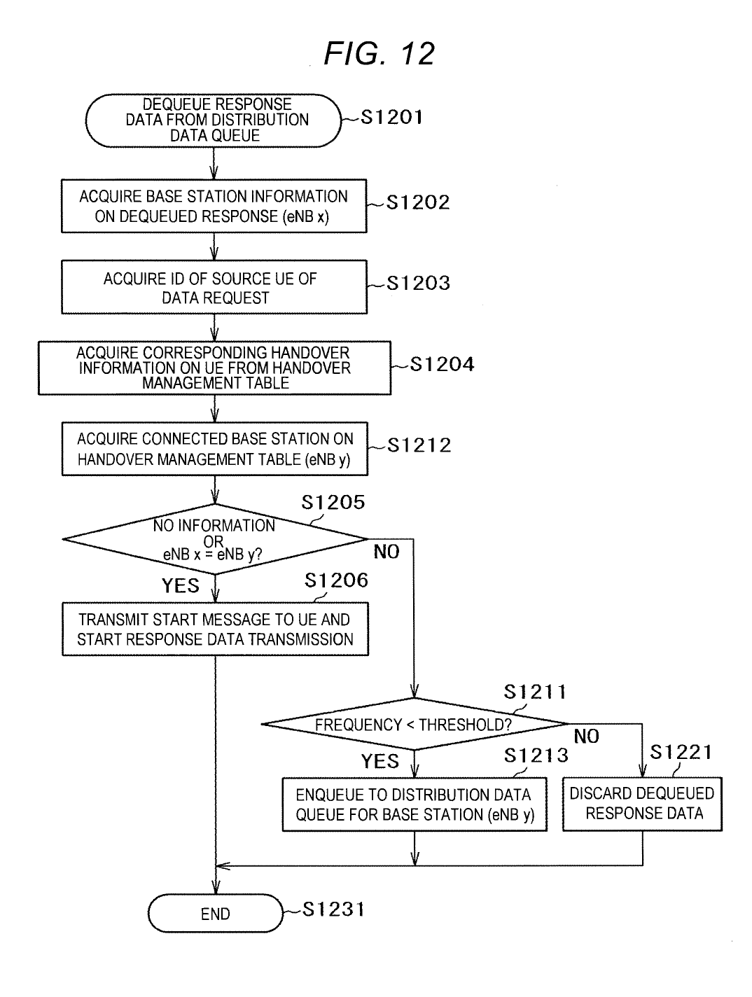

The DT-GW 60 checks the handover condition of the UE 10 with reference to the handover management table in FIG. 10 when dequeuing from a data request queue or a distribution data queue. FIG. 11 illustrates processing for dequeuing from a data request queue in the DT-GW 60. FIG. 12 illustrates processing for dequeuing from a distribution data queue in the DT-GW 60.

FIG. 9 illustrates a case where a handover occurs and the movement of the UE 10 is notified from the S-GW 40 to the DT-GW 60. However, also when the UE 10 moves across a paging area, the movement of the UE 10 is notified from the S-GW 40 to the DT-GW 60 (S909), and the DT-GW 60 performs update processing on the handover management table (S910).

The processing of dequeuing from a data request queue by the DT-GW 60 will be described with reference to FIG. 11. When the DT-GW 60 dequeues a data request from a data request queue (S1101), the DT-GW 60 first acquires base station information in the dequeued data request (S1102). It is assumed here that the base station information in the dequeued data request is (eNBx). Next, the DT-GW 60 acquires UE information (UE ID) on the UE 10 having issued the data request (S1103) and acquires the handover information 1052 on the UE 10 having the UE ID from the handover management table (S1104). It is assumed here that the connected base station information 1062 contained in the acquired handover information is (eNB y) (S1111).

If information on the corresponding UE ID is not contained in the handover management table or if the acquired base station information is matched with (eNB x) (Yes in S1105), the DT-GW 60 transmits the dequeued data request to the data distribution server 90 and receives response data from the data distribution server 90. The DT-GW 60 enqueues the data request and the response data from the data distribution server 90 to a distribution data queue for the base station (eNBx) (S1106), and the processing ends (S1121). If the acquired connected base station information 1062 is not matched with (eNB x) (No in S1105), the DT-GW 60 enqueues the dequeued data request to a data request queue for the base station (eNB y) (S1112), and the processing ends (S1121).

In the example in FIG. 11, if a movement of the UE 10 is detected in step S1105 (if eNB x is different from eNB y), the dequeued data request is again enqueued to the data request queue (S1112). However, a data request may be issued to the data distribution server 90, and the data request and the response data from the data distribution server 90 may be enqueued to a distribution data queue for the base station (eNB y). Alternatively, the UE 10 may add a priority level to each data request, and one of the two methods above may be used in accordance with the priority level.

Next, the processing of dequeuing response data from a distribution data queue by the DT-GW 60 will be described with reference to FIG. 12.

When the DT-GW 60 dequeues a response data from a distribution data queue (S1201), the DT-GW 60 first acquires base station information in the dequeued response data (S1202). It is assumed here that the base station information is (eNB x). Next, the DT-GW 60 acquires the UE information (UE ID) on the UE 10 having issued the data request (S1203) and acquires the handover information 1052 on the UE 10 having the UE ID from the handover management table (S1204). It is assumed here that the connected base station information 1062 contained in the acquired handover information is (eNB y) (S1212).

If information on the corresponding UE ID is not contained in the handover management table or if the acquired base station information is matched with (eNB x) (Yes in S1205), the DT-GW 60 transmits a start message to the UE 10 first and then starts transmitting response data. Then, the processing ends (S1231). If the acquired connected base station information 1062 is matched with (eNB x) (No in S1205), the DT-GW 60 compares between the frequency information 1063 in the handover information 1052 and a predetermined threshold value (S1211).

If the frequency information 1063 is lower than the predetermined threshold value (Yes in S1211), the dequeued response data is enqueued to a distribution data queue for the acquired base station (eNB y) (S1213), and the processing ends (S1231). The enqueuing response data in step S1213 may be performed by enqueuing to a preliminary queue for the base station (eNB y). If the frequency information 1063 is equal to or higher than the predetermined threshold value (No in S1211), the response data dequeued in S1201 is discarded (S1221), and the processing ends (S1231).

The first embodiment described above may provide at least the following effects (A1) to (A11).

(A1) Because it is configured such that both of delay-intolerant data communication and delay-tolerant data communication may be performed, a data communication with a small tolerant delay may only be performed when a network to be used is busy. A data communication with a small tolerant delay and a data communication with a large tolerant delay may be performed when the network is not busy. For example, because traffic running in the background, such as a traffic relating to an update on an OS or an application, for example, is a data communication with a large tolerant delay, the data communication is implemented when the network is not busy. This may prevent congestion of the network and allows effective use of network resource.

(A2) A DT-GW which implements a delay-tolerant data communication has a data request queue and a distribution data queue such that a data request may be dequeued from a data request queue in accordance with the queue length of the distribution data queue. This easily allows a data communication with a small tolerant delay only to be implemented when the network is busy and a data communication with a large tolerant delay to be implemented when the network is not busy.

(A3) Because a data request queue and a distribution data queue are provided for each base station, a data communication may be performed in accordance with the busy condition of each base station. In other words, a data communication with a small tolerant delay may only be implemented to a busy base station, and a data communication with a large tolerant delay may be implemented to a base station that is not busy.

(A4) When a base station to which a mobile terminal is connected is changed, a data request within a data request queue is dequeued and is then enqueued to a data request queue for the changed base station. Thus, distribution data from the data distribution server may be transmitted to the changed base station.

(A5) when the base station to which a mobile terminal is connected is changed, distribution data within the distribution data queue is dequeued and is enqueued to a distribution data queue for the changed base station. Thus, distribution data may be securely transmitted to the changed base station.

(A6) Because a preliminary queue is provided in a distribution data queue, the data transmission to the mobile terminal may not be waited when a handover of the mobile terminal occurs or when the mobile terminal crosses over a paging area.

(A7) Because a transmission band list which limits a transmission band from a DT-GW to a base station is provided in a DT-GW which implements a delay-tolerant data communication, the transmission band from the DT-GW to the base station may be set to an appropriate value.

(A8) A DT-GW receives load information indicative of a radio transmission load state from a base station to a mobile terminal and adjusts the transmission band for transmitting response data to the base station in accordance with the received radio transmission load state. Thus, the transmission band from the DT-GW to the base station may be set to an appropriate value.

(A9) If the frequency of occurrence of handover of a mobile terminal is equal to or higher than a predetermined value, distribution data from a data distribution server is discarded. In other words, data distribution to a mobile terminal while moving may be inhibited. Thus, the efficiency of use of the network may be improved.

(A10) If data distribution in response to a data request is not implemented within a predetermined period of time, a data request may be issued from the mobile terminal again. This may simplify a communication sequence from data request to data distribution. The predetermined period of time may be differentiated in accordance with the priority levels of data requests. Thus, the frequency of issuing data requests with higher priority levels may be higher than the frequency of issuing data requests with lower priority levels.

(A11) The DT-GW added to an existing system allows easy configuration of a radio communication system which may implement both delay-intolerant data communication and delay-tolerant data communication.

### Second Embodiment

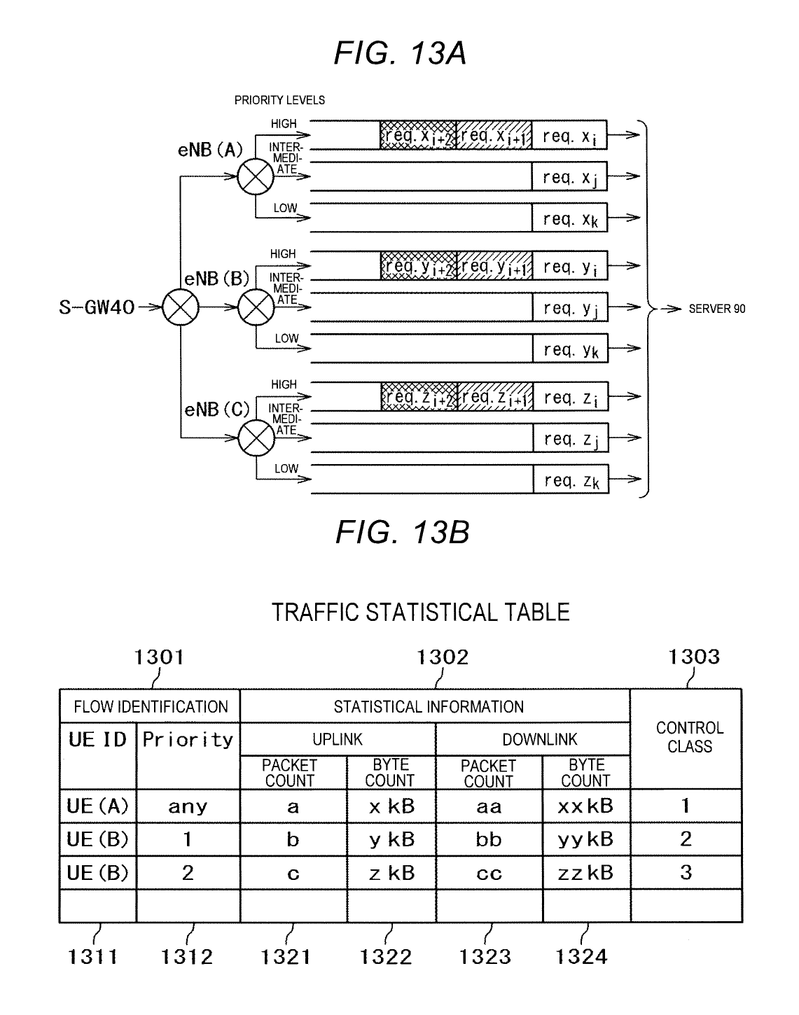

A second embodiment of the invention will be described with reference to FIG. 13A. FIG. 13A illustrates a data request queue according to the second embodiment. The second embodiment has a similar configuration to that of the first embodiment except for a data request queue in the DT-GW 60. In other words, a data request queue according to the first embodiment has one queue or a plurality of equivalent queues for each base station. On the other hand, according to the second embodiment, a plurality of queues with different weights are provided as illustrated in FIG. 13A.

More specifically, FIG. 13A illustrates an example in which a plurality of queues based on priority levels are provided for each base station, that is, three queues with high, low and intermediate priority levels are provided for each base station. A queue with a high priority level is output from a data request queue with a higher priority level than others, while a queue with a low priority level is output from the data request queue with a lower priority level than others. Every time when receiving a data request from the UE 10, the DT-GW 60 gives a priority level to the data request on the basis of an attribute of the UE 10 or the priority level of the data request and allots it to a data request queue with a high, intermediate or low priority level in accordance with the priority level of the data request. A data request in a queue with a high priority level is output from the queue and is transmitted to the data distribution server 90 by priority. The attribute of the UE 10 here may be, for example, handover frequency information 1063 illustrated in FIG. 10, a downlink packet count 1323 illustrated in FIG. 13B (traffic statistical table), which will be described below, or the like. The data request priority may be the priority 614 on the request management table in FIG. 6, for example.

Giving a priority level to a data request, for example, allows giving a low priority to requests from a heavy user with a high downlink packet count 1323 so that the unfair state in the use of the network may be corrected. The second embodiment is different from a data communication in the past in that when a network to be used is not busy, a heavy user and a general user may implement equivalent communications while when the network is busy, communications to a heavy user are inhibited and receive a low priority.

A method which uses a traffic statistical table (FIG. 13B) held by the DT-GW 60 will be described as an example of a specific method of allotting a data request to a data request queue in FIG. 13A. FIG. 13B illustrates a traffic statistical table that the DT-GW 60 has in the storage unit 62 according to the second embodiment. As illustrated in FIG. 13B, the traffic statistical table has flow identification 1301, statistical information 1302, and control class 1303. The flow identification 1301 contains UE ID 1311 and priority 1312. The priority 1312 is identical to the priority 614 in FIG. 6 and is received and acquired by the DT-GW 60 from the UE 10. The statistical information 1302 contains uplink and downlink cumulative packet counts (1321 and 1323) and cumulative byte counts (1322 and 1324). The term uplink refers to a direction from the UE 10 to the DT-GW 60, and the term downlink refers to a direction from the DT-GW 60 to the UE 10. Under the control class 1303, a control priority level of the corresponding flow, which is calculated on the basis of its statistical information 1302. For example, if the sum S of the cumulative byte counts (1323 and 1324) under the statistical information 1302 is equal to or lower than a predetermined threshold value t1, “1” is assigned to the control class 1303. If t1<S≦t2, “2” is assigned. If t2<S, “3” is assigned.

The DT-GW 60 uses the control class 1303 to allot a data request to the data request queue in FIG. 13A. For example, when a data request is transmitted from the UE 10 with a high priority level (“1” in this example) under the control class 1303, the data request may be transmitted to a data request queue with a “high” priority level. When a data request is transmitted from the UE 10 with a low priority level (“3” in this example) under the control class 1303, the data request may be transmitted to a data request queue with a “low” priority level.

Alternatively, the handover management table in FIG. 10 may be used to allot data requests. For example, when a data request is transmitted from the UE 10 with handover frequency information 1063 that is equal to or higher than a predetermined threshold value, the data request may be transmitted to a data request queue with a “low” priority level. When a data request is transmitted from the UE 10 with handover frequency information 1063 that is lower than the predetermined threshold value, the data request may be transmitted to a data request queue with a “high” priority level.

Alternatively, it may be determined on the basis of the priority 1312 of a data request transmitted from the UE 10 that is a user, or it may be determined by a combination of the aforementioned methods.

Every time when a communication to/from the UE 10 occurs, the DT-GW 60 updates the traffic statistical table and transmits it to a billing server periodically such as once a month or when a counter in the statistical information 1302 overflows. Then, the DT-GW 60 resets the statistical values on the traffic statistical table to zero. Here, a field having the statistical information 1302 may only be reset to zero, and the control class 1303 may be held as it is. Holding the control class 1303 as it is allows continuous control according to the traffic between the DT-GW 60 and the UE 10.

When the control class 1303 is held as it is in the zero reset, past control class information may be used to determine the control class 1303 by, for example, adopting, as a value of the control class, a MAX ({past control class before the zero reset}, {control class calculated from the statistical information after the zero reset}), that is, a larger control class calculated from a past control class before the zero reset and statistical information after the zero reset.

Data distribution according to the frequency of use of a user to a data request with a large tolerant delay may correct the unfair use of network resources between users. For example, this may prevent a problem that the occupation of a band by a heavy user deteriorates the communication quality for general users and general users may have hard time to connect to the network. For example, the shift from flat rate charging without regard to traffic to charging on an as-used basis might be strongly rejected. However, according to the second embodiment, the shift to charging on an as-used basis may be avoided.

The second embodiment described above may provide at least the following effects (B1) to (B4) in addition to the effects of the first embodiment.

(B1) Because a data request queue has a plurality of queues according to priority levels of base stations, distribution data from a data distribution server may be distributed to a mobile terminal in accordance with the priority levels. Thus, for example, by giving a lower priority level to a data request from a heavy user, the occupation of a band by the heavy user may be inhibited when the network is busy.

(B2) When the priority levels are set in accordance with the traffic between the DT-GW and mobile terminals, the data distribution to a high traffic mobile terminal may be inhibited.

(B3) When the priority levels are set in accordance with the priority levels of users (mobile terminals), data distribution to a mobile terminal with a low priority level may be inhibited.

(B4) When the priority levels are set in accordance with the frequencies of handover of mobile terminals, data distribution to a mobile terminal with many handovers may be inhibited.

### Third Embodiment

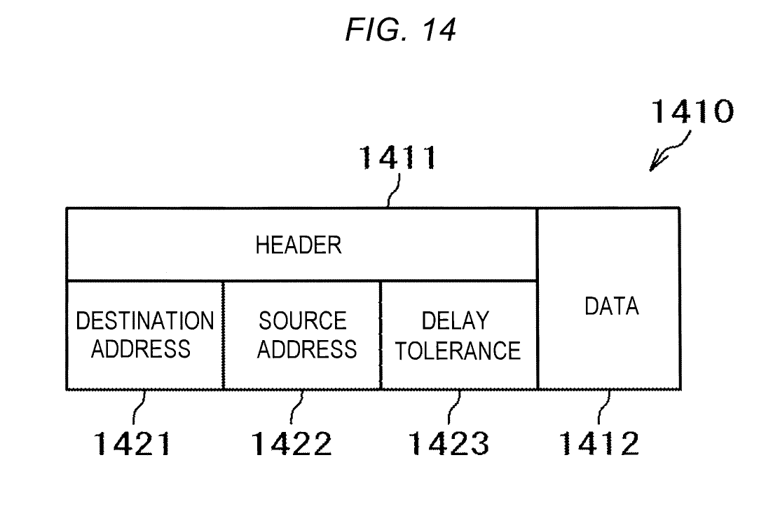

A third embodiment of the invention will be described with reference to FIG. 14. The third embodiment is similar to the first embodiment except for a method of transmitting a data request by a UE 10. According to the first embodiment, when the data acquisition method is selected by a UE 10 (or automatically selected or selected by a user) and an existing data communication 310 is used, a communication destined to the data distribution server 90 which holds the data to be acquired is established. On the other hand, when a delay-tolerant data communication 320 is used, a communication destined to the DT-GW 60 is established.

According to the third embodiment, the UE 10 adds a flag indicative of whether the data is delay tolerant or not to a packet header and transmits it.

FIG. 14 illustrates a packet format to be transmitted from the UE 10 according to the third embodiment. As illustrated in FIG. 14, a packet 1410 has a header 1411 and data 1412. The header 1411 includes a destination address 1421, a source address 1422, and delay tolerance information 1423. The destination address 1421 is different from the destination address (DT-GW 60) according to the first embodiment but is an address of the data distribution server 90. The source address 1422 is an address of the UE 10. The delay tolerance information 1423 may be a bi-level value indicative of either one that requires immediate communication and the one that does not or may be divided into different levels and have a plurality of levels.

A communication sequence according to the third embodiment is similar to the sequence of the first embodiment illustrated in FIG. 3, and the UE 10 transmits a packet 1410 including the delay tolerance information 1423 illustrated in FIG. 14. When receiving the packet 1410, the S-GW 40 determines whether it is to be transmitted through the existing data communication 310 or through the delay-tolerant data communication 320 on the basis of the delay tolerance information 1423 in the packet header 1411 and transfers the packet 1410 through the determined communication. In other words, if the delay tolerance information 1423 includes “immediate communication is necessary”, the packet is transferred to the P-GW 50. If it includes “delay tolerant communication 320”, the packet is transferred to the DT-GW 60.

The third embodiment described above may provide at least the following effect (C1).

(C1) Because a packet transmitted from a mobile terminal contains the delay tolerance information, the mobile terminal may implement a communication destined to the data distribution server 90 in the same manner as that for an existing data communication.

### Fourth Embodiment

A fourth embodiment of the invention is similar to the first embodiment and third embodiment except for a method for transmitting a data request by a UE 10. In other words, according to the first embodiment and third embodiment, the data acquisition method may be selected by a UE 10, the other communication party is selected or delay tolerance information is added to a packet. According to the fourth embodiment, a UE 10 performs the data communication 310 as in the past.

The S-GW 40 analyzes a packet transmitted from the UE 10 and determines whether any delay is tolerant or not. If it is determined that a delay is tolerant, the path for the packet relating to the session is changed to the DT-GW 60. If it is determined that a delay is not tolerant, the path for the packet is changed to the P-GW 50.

The fourth embodiment described above may provide at least the following effect (D1).

(D1) Also in a delay-tolerant data communication, a mobile terminal may perform a similar communication to a delay-intolerant data communication in the past, and an S-GW determines whether a delay is tolerant or not. Thus, a mobile terminal may perform an operation as in the past.

### Fifth Embodiment

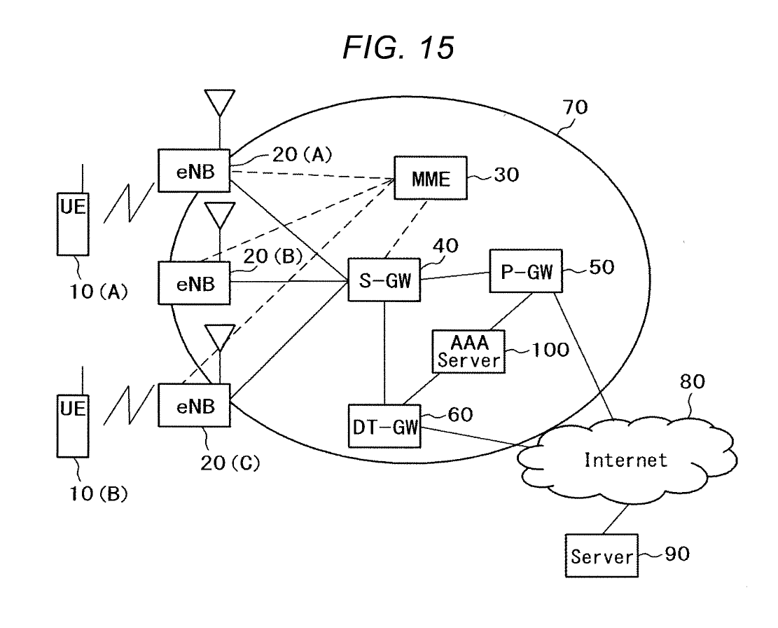

A fifth embodiment of the invention will be described with reference to FIG. 15. FIG. 15 is a schematic configuration diagram of a radio communication system according to the fifth embodiment. The fifth embodiment relates to a billing method when the delay-tolerant data communication 320 according to the first to fourth embodiment is used.

As illustrated in FIG. 15, a billing server (AAA Server: Authentication Authorization Accounting Server) 100 is connected to the P-GW 50 and the DT-GW 60. The billing server 100 includes a CPU (Central Processing Unit), a switch processing unit, a volatile memory, a non-volatile memory, and a communication interface (I/F), like the hardware configuration of a mobile gateway apparatus. Operations of the billing server 100 are controlled by a control unit including the CPU and the switch processing unit.

A charge for the existing data communication 310 may be calculated by the billing server 100 by acquiring a traffic of each UE 10 from the P-GW 50 and multiplying the acquired traffic by a communication unit price. The P-GW 50 uses a table corresponding to the traffic statistical table in FIG. 13B to manage a downlink traffic, for example, of each UE 10 and transmits statistical information to the billing server 100 periodically or a count in the statistical information overflows.

A charge for the delay-tolerant data communication 320 is calculated by the billing server 100 by acquiring a traffic of each UE 10 from the DT-GW 60 and multiplying the acquired traffic by a communication unit price. The DT-GW 60 uses the traffic statistical table in the FIG. 13B to manage a downlink traffic, for example, of each UE 10 and transmits statistical information to the billing server 100 periodically or a counter in the statistical information overflows.

The billing server 100 separately performs the billing processing on the existing data communication 310 and the billing processing on the delay-tolerant data communication 320 and then adds the former and the latter and bills a user. Providing a significantly low communication unit price or an upper limit of charges for the delay-tolerant data communication 320 may offer the use of a smart phone and/or a PC to users who want to keep the cost as low as possible. Because the delay-tolerant data communication 320 is available, a user may feel less resistant to the shift of the charging for the existing data communication 310 to charging on an as-used basis. In other words, when an immediate communication is necessary, the existing data communication 310 is used by paying its cost. The delay-tolerant data communication 320 may be selected for lower costs.

The fifth embodiment described above may provide at least the following effect (E1).

(E1) The billing processing for a delay-tolerant data communication and the billing processing for a delay-intolerant data communication may be performed separately. Thus, data communications which have been immediately implemented but actually are delay-tolerant may be easily guided to the delay-tolerant data communication.

The invention is not limited to the aforementioned embodiments, and various changes may be made without departing from the spirit and scope of the invention.

According to the first embodiment, both of the processing for dequeuing from the data request queue illustrated in FIG. 11 and processing for dequeuing response data from the distribution data queue illustrated in FIG. 12 may be performed. However, the processing illustrated in FIG. 11 may be omitted.

Having described according to the first embodiment to fifth embodiment that the S-GW 40 and the DT-GW 60 are separate apparatuses, the S-GW 40 and DT-GW 60 may be configured as one apparatus. Alternatively, the P-GW 50 and DT-GW 60 may be configured as one apparatus. Alternatively, the S-GW 40, DT-GW 60 and P-GW 50 may be configured as one apparatus. Alternatively, the S-GW 40, DT-GW 60, P-GW 50, and MME 30 may be configured as one apparatus. Alternatively, the S-GW 40, DT-GW 60, P-GW 50, MME 30, and billing server 100 may be configured as one apparatus.

The configurations according to the first embodiment to fifth embodiment may be combined appropriately.

The invention may be understood as not only a system of executing processing according to the invention but also an apparatus or method configured in the system, a program for implementing the method, or a recording medium which records the program.

What is claimed is:

1. A radio communication system comprising:
a mobile terminal;
a plurality of base stations connected by radio to the mobile terminal;
a gateway apparatus connected to the plurality of base stations; and
a data distribution server which is connected to the gateway apparatus over the Internet and which distributes data to the mobile terminal,
wherein the mobile terminal transmits a first data request and a second data request to the data distribution server through the base station and the gateway apparatus;
when the gateway apparatus receives the first data request from the base station, the gateway apparatus transmits the received first data request to the data distribution server independent of a radio transmission load state from the base station to the mobile terminal;
when the gateway apparatus receives the second data request from the base station, the gateway apparatus transmits the received second data request to the data distribution server with a delay in accordance with a radio transmission load state from the base station to the mobile terminal; and
when the data distribution server receives the first data request or the second data request from the gateway apparatus, the data distribution server transmits data requested by the first data request or second data request as response data to the mobile terminal through the gateway apparatus and the base station.

2. The radio communication system according to claim 1, wherein the gateway apparatus has, for each of the plurality of base stations,
a data request queue which stores a plurality of the received second data requests and outputs them in order of the storage; and
a distribution data queue which stores a plurality of response data received from the data distribution server and outputs them in order of the storage, and
if the number of response data stored in the distribution data queue is lower than a predetermined threshold value, outputs and transmit the second data request stored in the data request queue to the data distribution server.

3. The radio communication system according to claim 2, wherein if the base station connecting to the mobile terminal is changed from a first base station to a second base station after the gateway apparatus receives the second data request from the mobile terminal, the gateway apparatus outputs the response data stored in the distribution data queue for the first base station and then inputs the output response data to the distribution data queue for the second base station.

4. The radio communication system according to claim 3, wherein:
the second data request stored in the data request queue includes base station information by which a base station connecting to a mobile terminal which has transmitted the second data request is identified; and
if the base station connecting to the mobile terminal is changed from a first base station to a second base station after the gateway apparatus receives the second data request from the mobile terminal, the gateway apparatus outputs the second data request stored in the data request queue for the first base station and then changes the base station information on the first base station included in the output second data request to the base station information on the second base station and inputs the second data request having the changed base station information to the data request queue for the second base station.

5. The radio communication system according to claim 3, wherein:
if the base station connecting to the mobile terminal is changed at a frequency that is higher than a predetermined threshold value, the gateway apparatus outputs the response data stored in the distribution data queue for the first base station and then discards the output response data without inputting it to the distribution data queue for the second base station.

6. The radio communication system according to claim 2, wherein
a data request queue provided for each of the base stations includes a plurality of queues having different priority levels output from the data request queue; and
if the gateway apparatus receives the second data request from the mobile terminal, the gateway apparatus allots the received second data request to a plurality of queues having different priority levels in accordance with the priority level of the received second data request.

7. The radio communication system according to claim 3, wherein
the distribution data queues include a normal queue and a preliminary queue for each of the plurality of base stations; and
the gateway apparatus
inputs the response data received from the data distribution server to the normal queue; and
if the base station connecting to the mobile terminal is change from a first base station to a second base station after the gateway apparatus receives the second data request from the mobile terminal, outputs the response data stored in the normal queue for the first base station and then inputs the output response data to the preliminary queue for the second base station.

8. The radio communication system according to claim 1, wherein if the mobile terminal does not receive response data to a data request within a predetermined period of time after the mobile terminal transmits the data request, the mobile terminal again transmits the same data request as the one transmitted last to the base station.

9. The radio communication system according to claim 8, wherein the mobile terminal stores for each of transmitted data requests, a program identifier for identifying a program in the mobile terminal having transmitted a data request and a priority level of the program and differentiates the predetermined period of time in accordance with the priority level of the program.

10. The radio communication system according to claim 1, wherein the gateway apparatus receives load information describing the radio transmission load state from the base station and adjusts a transmission band for transmitting the response data to the base station in accordance with the received radio transmission load state.

11. The radio communication system according to claim 1, wherein the gateway apparatus includes
a first gateway apparatus connected to the plurality of base stations;
a second gateway apparatus connected to the first gateway apparatus and the data distribution server; and
a third gateway apparatus connected to the first gateway apparatus and the data distribution server, and
if the second gateway apparatus receives the first data request from the base station, the second gateway apparatus transmits the received first data request to the data distribution server independent of a radio transmission load state from the base station to the mobile terminal, and if the second gateway apparatus receives the response data from the data distribution server, the second gateway apparatus transmits the received response data to the base station, and
if the third gateway apparatus receives the second data request from the base station, the third gateway apparatus transmits the received second data request to the data distribution server with a delay in accordance with a radio transmission load state from the base station to the mobile terminal, and if the third gateway apparatus receives the response data from the data distribution server, the third gateway apparatus transmits the received response data to the base station.

12. A gateway apparatus comprising:
a data request queue which stores a plurality of data requests received from a mobile terminal and outputs them in order of the storage; and
a distribution data queue which stores a plurality of response data received from a data distribution server and outputs them in order of the storage, wherein
if the gateway apparatus receives a first data request from the mobile terminal, the gateway apparatus transmits the received first data request to the data distribution server;
if the gateway apparatus receives a second data request from the mobile terminal, the gateway apparatus stores the received second data request in the data request queue;
if the gateway apparatus receives data requested by the second data request as response data from the data distribution server, the gateway apparatus stores the response data in the distribution data queue; and
if the number of response data stored in the distribution data queue is lower than a predetermined threshold value, the gateway apparatus outputs the second data request stored in the data request queue and transmits it to the data distribution server.

13. A data distribution method in a radio communication system having
a mobile terminal;
a plurality of base stations wirelessly connected to the mobile terminal;
a gateway apparatus connected to the plurality of base stations; and
a data distribution server which is connected to the gateway apparatus over the Internet and which distributes data to the mobile terminal,
the method comprising the steps of:
transmitting a first data request to the data distribution server through the base station and the gateway apparatus by means of the mobile terminal;
transmitting a second data request to the data distribution server through the base station and the gateway apparatus by means of the mobile terminal;
after the gateway apparatus receives the first data request from the base station, transmitting the received first data request to the data distribution server independent of a radio transmission load state from the base station to the mobile terminal by means of the gateway apparatus;
after the gateway apparatus receives the second data request from the base station, transmitting the received second data request to the data distribution server with a delay in accordance with a radio transmission load state from the base station to the mobile terminal by means of the gateway apparatus; and
after the data distribution server receives the first data request or the second data request from the gateway apparatus, transmitting data requested by the first data request or second data request as response data to the mobile terminal through the gateway apparatus and the base station by means of the data distribution server.
